(19) United States
(12) Patent Application Publication
(10) Pub. No.: US 2026/0045978 A1
(43) Pub. Date: Feb. 12, 2026

(54) MIMO-OTFS TRANSMISSION AND RECEPTION WITH PARTIAL LOADING FOR COVERAGE ENHANCEMENT IN NEXT GENERATION WLAN COMMUNICATION SYSTEMS

(71) Applicant: INDIAN INSTITUTE OF TECHNOLOGY KHARAGPUR, KHARAGPUR (IN)

(72) Inventors: Chaithanya Velampalli, Kharagpur (IN); B. V. Sudhakar Reddy, Kharagpur (IN); Suvra Sekhar Das, Kharagpur (IN)

(21) Appl. No.: 18/968,421

(22) Filed: Dec. 4, 2024

(30) Foreign Application Priority Data
Aug. 6, 2024 (IN) 202431059500

(51) Int. Cl. H04B 7/0456

(52) U.S. Cl. CPC H04B 7/0456

(57) ABSTRACT

The present invention discloses a communication system including WLAN communication systems comprising transmitter including an OTFS grid based Orthogonal Time Frequency Space (OTFS) waveform generator and Multiple Input Multiple Output (MIMO) streams. The transmitter comprises signal processor including OTFS modulator having FEC (forward error correction) encoder for pre-FEC bit appended input data stream and transmission of encoded input data stream in a selective sequence vide OTFS waveform modulated OTFS grid-partially loaded with QAM/PSK symbols of said encoded input data stream through MIMO transmitter and receiver streams including MIMO pre-coder based multi antenna support for said transmission and reception of said OTFS waveform thereby enabling OTFS waveform transmission and retrieval of input data stream.

### FIELD OF INVENTION

The present invention relates to a novel data transmission methodology involving orthogonal time frequency space [OTFS] modulation, LDPC [Low Density Parity Check] codes, multistream transmission along with partial loading for wireless local area networks [WLAN] systems. The transmission includes OTFS grid which is loaded with less number of QAM/PSK symbols than the available grid points [QAM: quadrature amplitude modulation, PSK: phase shift keying]. Empty grid points are loaded with zero symbols. This partially loaded OTFS grid-based transmission provides significant SNR (Signal to Noise Ratio) advantage in error performance leading to communication coverage enhancement and link reliability.

### BACKGROUND ART

In the field of next generation WLAN [wireless local area networks] communication systems, researchers have identified that OTFS waveform to provide better error performance because of its capability to extract channel diversity. While exploring Wi-Fi standards, OTFS based transmission with LDPC FEC (Low-density-parity-check forward error correction) and multi-stream transmission and partial loading of OTFS grid is not found to be addressed.

The existing transmission methodology involving OFDM supports convolutional codes with multistream transmission with optional support for LDPC Codes till 802.11ax. From 802.11 be onwards the support for LDPC is made mandatory for devices supporting 40 MHz bandwidth.

Ramjee Prasad[OFDM for Wireless Communications Systems, Artech, 2004] provides a detailed description of OFDM waveform generation. Suvra Sekhar Das & Ramjee Prasad[Orthogonal Time Frequency Space Modulation: OTFS a waveform for 6G, River Publishers, 2021] provides a detailed description of OTFS waveform generation. IEEE, “Wlan 802.11ax,” Wi-Fi 6, 2021 provides a detailed description of the Wi-Fi 6 standard.

Devan Namboodiri in “Wireless Local Area Networks using orthogonal time frequency space modulation” [US patent No: U.S. Pat. No. 11,283,561B2], provides the method of modulation of data part of Wi-Fi signal using OTFS modulation. Only convolutional encoding is considered in this prior art. Loading reduced number of QAM/PSK symbols on OTFS grid is proposed but only for convolutional encoding and SISO Configuration.

Chaithanya Velampalli et. al in “MIMO-OTFS Transmission and Reception for Next Generation WLAN Communication Systems” [Indian Patent Application number 202431059214] provides OTFS based transmission with MIMO and LDPC support but without partial loading for WLAN systems.

Existing solutions lack support for multistream transmission with OTFS and LDPC FEC with partial loading.

The present invention therefore targets to develop a new transmission methodology for OTFS waveform with multistream support and LDPC Encoding and Decoding with partial loading.

### OBJECTS OF THE INVENTION

It is thus the basic object of the present invention to provide for suitable transmitter architecture for an Orthogonal Time Frequency Space (OTFS) waveform with Multiple Input Multiple Output (MIMO) configuration for future Wi-Fi systems with partial loading feature.

It is another object of the present invention to develop for a transmitter architecture wherein a new method of calculation of number of code blocks is based on APEP length, coderate, length of LDPC codeblocks, number of streams and partial load factor.

It is still another object of the present invention to provide for a new method of OTFS grid size calculation based on partial load factor to improve error performance leading to signal to noise ratio (SNR) gain to achieve improved coverage and reliability of the link.

### SUMMARY OF THE INVENTION

Thus, according to the basic aspect of the present invention provided a WLAN communication systems comprising:
transmitter including an OTFS grid based Orthogonal Time Frequency Space (OTFS) waveform generator and Multiple Input Multiple Output (MIMO) streams,
wherein said transmitter comprising signal processor including OTFS modulator having FEC (forward error correction) encoder for pre-FEC bit appended-input data stream and transmission of encoded input data stream in a selective sequence vide OTFS waveform modulated OTFS grid partially loaded with QAM/PSK symbols of said encoded input data stream through MIMO transmitter and receiver streams including MIMO pre-coder based multi antenna support for said transmission and reception of said OTFS waveform thereby enabling OTFS waveform transmission and retrieval of input data stream.

The above system, said transmitter include
at least an input unit with the FEC encoder unit to receive input data stream and encode the same into LDPC code blocks divided across spatial streams;
said signal processor for processing the code block and obtaining corresponding QAM/PSK (quadrature amplitude modulation/phase shift keying) symbols of the data streams for including in a data vector of a length and partially loading vectors onto OTFS data grid; and
at least an input domain of MIMO pre-coding block based OTFS modulator having an inverse symplectic fast Fourier transform (ISFFT) based OTFS modulator for OTFS modulation of the data vector giving an output facilitated by multi-antenna transmission of ‘P’ parallel data streams matched to ‘T’ antennas for transmission;
at least an output domain of MIMO pre-coding block associated to OFDM modulator for communicating and mapping the MIMO output to OFDM modulator to generate time domain OFDM symbol, whereby said OFDM symbol through OFDM modulator is passed to a digital to analogue (D/A) converter and Radio Frequency (RF) chain for transmission at each mapped antenna.

In a preferred embodiment of the above system, in said input unit prepend the input data stream with service bits, appended by Pre-FEC bits followed by scrambling the bit sequence at a scrambler module that is then LDPC encoded at the FEC encoder module giving encoded LDPC codeblocks CB₁, CB₂, CB₃ . . . CBₚ at the output divided across spatial streams based on codeblock arrangement sequence in relation to desired signal processing.

In a preferred embodiment of the above system, the signal processor for processing the code blocks in sequence include processing through bit interleaver, symbol mapper, post FEC symbol appender, symbol interleaver followed by power scalar for obtaining said corresponding QAM/PSK (quadrature amplitude modulation/phase shift keying) symbols per stream for including in a data vector and partially loading symbols/vectors onto OTFS waveform based data grid.

In a preferred embodiment of the above system, the processor is configured for said partial loading I number of symbols, where I<MN number of QAM/PSK symbols transmitted instead of full (MN) number of symbols and I and MN are related to each other by ‘α’ which is a factor for partial loading as

$$I = α MN \qquad ( 1 )$$

and if the symbol vector is denoted by d=[d[0], d[1], . . . , d[i], . . . , d[I−1]]T for transmission in partial loading, such symbol vectors are sparsely loaded into M×N matrix \tilde{X} in a systematic form by maintaining a distance of β₁ between two consecutive symbols along row dimension and distance β₂ along the columns dimension with zero symbols filled in other positions of sparsely loaded matrix X where β₁ and β₂ are related to ‘α’ by the equation

$${β}_{1} {β}_{2} = 1 / α \qquad ( 2 )$$

and with the elements/components of vectors x(l, k) of \tilde{X} for I=0, 1, . . . , M−1 and k=0, 1, . . . , N−1 expressed for partially loading as

$$\tilde{x} ( l , k ) = \{ \begin{matrix}d [ i ] & if l = {( i )}_{\frac{M}{\text{?}}} {β}_{1} and k = ⌊ \frac{\text{?}}{M} ⌋ {β}_{2} \\ 0 & Otherwise\end{matrix} . \qquad ( 3 )$$

$$\text{?} \text{indicates text missing or illegible when filed}$$

In a preferred embodiment of the above system, inverse symplectic fast Fourier transform (ISFFT) of the transmitter process the partially loaded data vector elements \tilde{x}(l, k) for OTFS modulation at the input domain side of MIMO pre-coding block based OTFS modulator as per the below

$${x}_{p} = ( {F}_{N}^{H} ⊗ {F}_{M} ) \tilde{x} , \qquad ( 4 )$$

where F_{N}^{H} is an inverse discrete Fourier transform (IDFT) matrix of order N and F_{M} is a DFT matrix of order M, and parameters M and N are grid parameters and their product MN=K, with OTFS grid size/parameters (M & N) computed such that if M, N denote the number of grid points on the delay dimension and N denote the number of grid points on the doppler dimension, the value of N within range N1 to N2 is processed based on the following computing logic:
(a) checking if Nₐₚₚₛ is exactly divisible with N2 (zero remainder);
(b) if yes, fixing the N value to N2;
(c) if no, the N value is decreased to N2−1 and repeating step (a) with N2−1;
(d) continuing computing until N=N1;
(e) once N is fixed calculating M as M=Nₐₚₚₛ/N; and
wherein for each k^{th} tone the input to the MIMO precoding block is expressed in terms of the OTFS samples xₚ=[xₚ(1), xₚ(2), . . . , xₚ(k), . . . xₚ(K)]^{T}, as

$$x ( k ) = {[ \begin{matrix}{x}_{1} ( k ) \\ {x}_{2} ( k ) \\ ⋮ \\ {x}_{p} ( k ) \\ ⋮ \\ {x}_{P} ( k )\end{matrix} ]}_{P \times 1} \qquad ( 5 )$$

In a preferred embodiment of the above system, at the MIMO precoding block the P input samples are mapped to T antennas that are then placed onto data subcarriers of N_{ofps} OFDM symbols at each antenna by OFDM modulator, with the pilot symbols also undergoing MIMO precoding separately and are mapped to antennas and placed onto the pilot subcarriers, wherein inverse fast Fourier transform (IFFT) operation is involved to generate each time domain OFDM symbol to which a cyclic prefix (CP) is added and the N_{ofps} OFDM symbols as the output are passed to a digital to analog (D/A) converter and Radio Frequency (RF) chain for transmission at each antenna with T antennas transmitting T time domain signals, . . . , s₁, s₂ . . . s_{T}

In a preferred embodiment of the above system, the processor is configured for computing number of Code Blocks N_{cb} and finding number of OFDM symbols for transmission is based on the following processing:
i. PSDU (Physical layer conformance procedure (PLCP) service data unit) length L_{psdu} in Bytes is first determined w.r.t to APEP length
ii. no. of Payload bits (N_{payloadbits}) is calculated by considering the service bits (N_{servbits})

$${N}_{payloadbits} = ( {L}_{p s d u} \times 8 ) / α + {N}_{servbits}$$

iii. the number of information bits (k) per code block (CB) are calculated as k=R*L_{ldpc} where R is the code rate and L_{ldpc} is the length of LDPC code blocks,
iv. the number of code blocks are then calculated as

$${N}_{cb} = ⌈ \frac{{N}_{payloadbits}}{k} ⌉$$

Where ┌ ┐ represents ceil operation,
v. in case the number of transmit streams (nₛₛ) are greater than 1 then the number of code blocks in the previous step are refined as

$${N}_{cb} = ⌈ \frac{{N}_{cb}}{{n}_{ss}} ⌉ * {n}_{ss}$$

vi. Calculation of no. of OFDM symbols per stream initial (N_{ofpsinit}): The number of OFDM symbols required for transmission per stream is calculated as

$${N}_{ofpsinit} = ⌈ \frac{{N}_{c b} \times {L}_{ldpc}}{{n}_{sd} \times {n}_{s s} \times m} ⌉ ,$$

n_{sd} is the no. of data sub carriers, m is bits per QAM/PSK symbol,
vii. the actual number of code blocks are calculated as N_{cb}=┌N_{cb}*α┐

In a preferred embodiment of the above system, said sequential arrangement of the codeblock is based on the following computation:
(a) in case of single transmit stream transmission no special arrangement of codeblocks is required before feeding into LDPC encoder;
(b) in case the number of transmit streams are greater than 1, then integer number of codeblocks are transmitted per stream before feeding into LDPC encoder;
(c) as a result code block arrangement is done per data stream as below:
(i) computing the minimum integer number of codeblocks that can be transmitted per stream

$$q = ⌊ \frac{{N}_{cb}}{{n}_{ss}} ⌋ ,$$

where └ ┘ indicates the floor operation,
(ii) computing the remaining codeblocks that are to be transmitted based on r=N_{cb}% nₛₛ (% is the modulo operation providing remainder after dividing Nob with nₛₛ) with the code block map corresponding to a code block arrangement per stream such that integer no. of code blocks are loaded per stream. Example arrangements are shown in tables below

| | | | | |
|---|---|---|---|---|
| Stream1 | CB1 | CB2 | CB3 | CB4 |
| Stream2 | CB5 | CB6 | CB7 | |
| Stream3 | CB8 | CB9 | CB10 | |
| Stream4 | CB11 | CB12 | CB13 | |

| | | | | |
|---|---|---|---|---|
| Stream1 | CB1 | CB2 | CB3 | |
| Stream2 | CB4 | CB5 | CB6 | CB7 |
| Stream3 | CB8 | CB9 | CB10 | |
| Stream4 | CB11 | CB12 | CB13 | |

| | | | | |
|---|---|---|---|---|
| Stream1 | CB1 | CB2 | CB3 | |
| Stream2 | CB4 | CB5 | CB6 | |
| Stream3 | CB7 | CB8 | CB9 | CB10 |
| Stream4 | CB11 | CB12 | CB13 | |

| | | | | |
|---|---|---|---|---|
| Stream1 | CB1 | CB5 | CB9 | CB13 |
| Stream2 | CB2 | CB6 | CB10 | |
| Stream3 | CB3 | CB7 | CB11 | |
| Stream4 | CB4 | CB8 | CB12 | |

the remaining ‘r’ code blocks will be less than no. of streams (nₛₛ) and the division of codeblocks is made such that each stream carries one code block starting from first stream.

In a preferred embodiment of the above system, said (QAM/PSK) symbols numbers per stream (Nₐₚₚₛ) is computed as Nₐₚₚₛ=N_{ofpsinit}×n_{sd} with the number of symbols per stream with the number of calculated codeblocks (N_{cbps}) are nₐₚₚₛ=[N_{cbps}×L_{ldpc}/m] in case the number of QAM/PSK symbols to be accommodated per stream, n_{apps_actual} is greater than available symbols nₐₚₚₛ, the number of symbols incremented by 1 i.e. N_{ofps}=N_{ofpsinit}+1 otherwise N_{ofps}=N_{ofpsinit}, with the final number of (QAM/PSK) symbols per stream being Nₐₚₚₛ=N_{ofps}×n_{sd}.

In a preferred embodiment of the above system, said Pre-FEC bits number computation is based on computing number of Pre-FEC bits to be appended before FEC encoding computed as N_{prefecbits}=N_{cb}×L_{ldpc}×R−L_{psdu}×8−N_{servbits} free of requirement of adding shorten bits before LDPC encoding and free of any puncturing after LDPC Encoding.

In a preferred embodiment of the above system, said number of Post-FEC symbols to be appended after FEC bit interleaving and symbol mapping per stream is computed as N_{postfecps}=Nₐₚₚₛ−nₐₚₚₛ where the total Post-FEC symbols are the sum of Post-FEC symbols per stream

$${N}_{postfec} = {\sum }_{j = 1}^{{n}_{ss}} {N}_{postfecps} ( j )$$

and post-EC symbols are populated with zeros in our transmission.

In a preferred embodiment of the above system, power scaling in cases where the N_{postfec} is a non zero number, the non-zero QAM/PSK symbols in each stream are power boosted by M×N/n_{qpps_actual}

In a preferred embodiment of the above system, said receiver with R receive antennas, receive data stream signals y₁, y₂ . . . y_{R} that undergo conversion from Radio Frequency (RF) to baseband, and are synchronized in time and frequency such that for each r^{th} receive antenna, after RF to baseband conversion and synchronization, OFDM demodulation is performed on the frame of (N_{ofps}) OFDM symbols by involving fast Fourier transform (FFT) and removal of the Cyclic Prefix (CP) for each OFDM symbol, whereby after OFDM demodulation, for a specific k^{th} tone the output from R receive antennas is computed in vector form as

$$y ( k ) = {[ \begin{matrix}{y}_{1} ( k ) \\ {y}_{2} ( k ) \\ ⋮ \\ {y}_{r} ( k ) \\ ⋮ \\ {y}_{R} ( k )\end{matrix} ]}_{R \times 1} , \qquad ( 6 )$$

where yᵣ(k) is the output for k^{th} tone from r^{th} receive antenna with the receiver adapted for data retrieval.

### BRIEF DESCRIPTION OF FIGURES

FIG. 1: illustrates Transmitter Blocks till FEC Encoder;

FIG. 2: illustrates Transmitter Blocks from output of FEC Encoder till power scaling;

FIG. 3: illustrates OTFS Modulator;

FIG. 4: illustrates the data grid with partial loading;

FIG. 5: illustrates Receiver Architecture according to the present invention;

FIG. 6: illustrates FER performance of the invented WLAN Transmitter and Receiver for different load configurations for 1 transmit and 1 receive antenna.

FIG. 7A: illustrates FER vs SNR plots for system with Transmit (T)×Receive (R): 1×1 with varying partial loads; and

FIG. 7B illustrates FER vs SNR plots for system with Transmit (T)×Receive (R): 1×2 with varying partial loads

### DETAILED DESCRIPTION OF THE INVENTION WITH REFERENCE TO THE ACCOMPANYING FIGURES

The present invention relates to a new transmission methodology for supporting OTFS modulation, LDPC codes, multistream transmission along with partial loading for WLAN systems. Wi-Fi is a family of standards developed by Institute of Electrical and Electronic Engineers (IEEE) for wireless local area networks (WLAN). The Wi-Fi standards include 802.11, 802.11b, 802.11g, 802.11a, 802.11n, 802.11ac, 802.11ax. 802.11be and 802.11bn are standards which are slated for future release. The waveform that is used till 802.11ax is orthogonal frequency division multiplexing (OFDM). Among the several features to be included in 802.11be, key features include support for 4096-QAM and 16 spatial streams and MIMO protocol enhancements.

Recently a new waveform orthogonal time frequency space (OTFS) is developed that exploits full channel diversity over time and frequency, which allows the OTFS modulation to significantly improve the performance. Due to backward compatibility with legacy OFDM systems in the prior arts, OTFS is implemented as a preprocessing stage to OFDM modulation.

Multiple input multiple output (MIMO) systems can transmit multiple parallel data streamsfor higher data rates. The standard uses convolutional codes for forward error correction as minimum requirement. LDPC codes are optional within the standard till 802.11ax but are mandatory from 802.11be for devices supporting higher bandwidths (greater than 20 MHz).

In the present advancement, the OTFS grid is loaded with less number of QAM/PSK symbols than the available gridpoints. Empty grid points are loaded with zero symbols. This methodology is termed as partial loading, wherein several dB's of SNR advantage is provided in error performance leading to coverage enhancement. This invention provides a new transmission methodology for supporting OTFS modulation, LDPC codes, multistream transmission along with partial loading for WLAN systems.

The PHY frame structure of 802.11ax standard has preamble, header and data fields. The preamble is used for time and frequency synchronization at the receiver. The header carries essential control information, including the data transmission rate and the payload length. The payload carries the actual data being transmitted. In OFDM transmissions each data subcarrier is regarded as one tone. These tones are loaded with quadrature amplitude modulation (QAM) or phase shift keying (PSK) symbols.

In a MIMO system, which includes multi-antenna transmission and reception, P data symbols are transmitted over each tone. Here, P represents the number of parallel data streams.

MIMO precoding is used to match the P streams to T antennas. There are two types of MIMO systems based on codebook selection
1. open loop
2. closed loop

In closed-loop systems, codebooks utilized for MIMO precoding, ensure that P≤T. The codebook selection depends on the channel state information (CSI) feedback from the receiver.

In open-loop MIMO, the number of streams, P is equal to the number of transmit antennas, denoted as T.

In OTFS, the inverse symplectic fast Fourier transform (ISFFT) is performed on the datasymbols before loading onto the tones.

### A. Transmitter

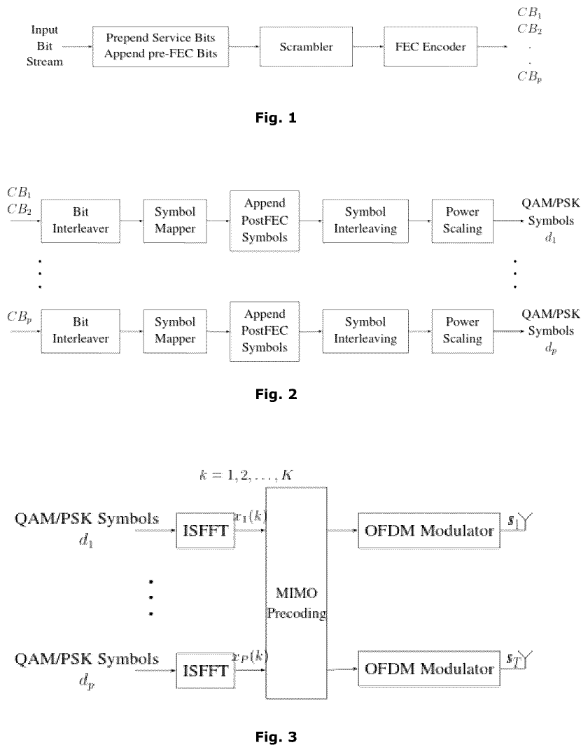

The present Transmission methodology involves OTFS waveform modulator, LDPC encoder and MIMO unit are outlined in FIG. 1, FIG. 2, and FIG. 3.

The input data stream is prepended with service bits in the input unit. Pre-FEC bits are appended. The bitsequence is then scrambled in the scrambler and FEC encoded in the FEC encoder as shown in the FIG. 1. The output of the FEC Encoder are the codeblocks CB₁, CB₂, CB₃ . . . CBₚ. The encoded codeblocks are divided across spatial streams as per the codeblock arrangement logic outlined in the later part of the document. Once the codeblocks are arranged the sequence of signal processing steps are performed as per FIG. 2.

### Partial Loading

In the partial loading, only a I<MN number of QAM/PSK symbols are transmitted instead of the full (MN) number of symbols. The I and MN are related by x which is a factor for partial loading as

$$I = α MN \qquad ( 1 )$$

Lets denote d=[d[0], d[1], . . . ,d[i], . . . , d[I−1]]^{T} as the symbol vector for transmission in partial loading. These symbols are sparsely loaded into an M×N matrix \tilde{X} in a systematic form with distance of β₁ between two consecutive symbols along row dimension and distance β₂ along column. Zero symbols are filled in other positions of \tilde{X}. β₁ and β₂ are related to α by equation

$${β}_{1} {β}_{2} = 1 / α \qquad ( 2 )$$

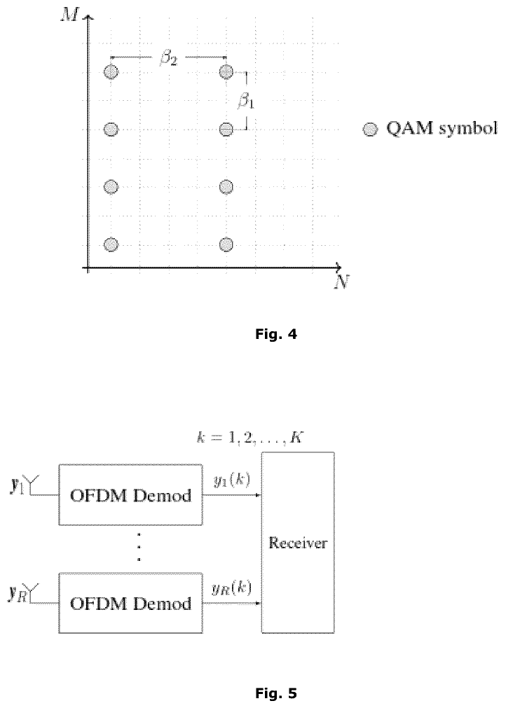

FIG. 4 shows a sparsely loaded symbol matrix for M=8 and N=8 with β₁ being 2 and β₂ being 4.

The elements x(l, k) of \tilde{X} for l=0, 1, . . . , M−1 and k=0, 1, . . . , N−1 is expressed as

$$\tilde{x} ( l , k ) = \{ \begin{matrix}d ⌊ i ⌋ & if & l = ( i ) \text{?} {β}_{1} and k = ⌊ \text{?} ⌋ {β}_{2} \\ 0 & & Otherwise\end{matrix} \qquad ( 3 )$$

$$\text{?} \text{indicates text missing or illegible when filed}$$

\tilde{x}(l, k) applied to inverse symplectic fast Fourier transform (ISFFT) for OTPS modulation

$${x}_{p} = ( {F}_{N}^{H} ⊗ {F}_{M} ) \tilde{x} , \qquad ( 4 )$$

where F_{N}^{H} is an inverse discrete Fourier transform (IDFT) matrix of order N and F_{M} is a DFT matrix of order M. The parameters M and N are grid parameters and their product MN=K. The calculation of OTFS grid parameters (M & N) is outlined in the later part of the document. For each k^{th} tone, the input to the MIMO precoding block is expressed in terms of the OTFS samples xₚ=[xₚ(1), xₚ(2), . . . , xₚ(k), . . . xₚ(K)]^{T}, as

$$x ( k ) = {[ \begin{matrix}{x}_{1} ( k ) \\ {x}_{2} ( k ) \\ ⋮ \\ {x}_{p} ( k ) \\ ⋮ \\ {x}_{P} ( k )\end{matrix} ]}_{P \times 1} \qquad ( 5 )$$

The MIMO precoding block maps the P input samples to T antennas. These samples are then placed onto the data subcarriers of N_{ofps} OFDM symbols at each antenna. Pilot symbols also undergo MIMO precoding separately and are mapped to antennas, where they are placed onto the pilot subcarriers. The inverse fast Fourier transform (IFFT) operation is used to generate each time domain OFDM symbol.

A cyclic prefix (CP) is then added and the N_{ofps} OFDM symbols are passed to the digital to analog (D/A) converter and Radio Frequency (RF) chain for transmission at each antenna. T antennas transmit T time domain signals, s₁,s₂, . . . ,s_{T}, as shown in FIG. 3. D/A converter and RF chain are not shown in the figure for ease of representation.

Required computations while employing the present transmission methodology are outlined as below.

1. Calculation of number of Code Blocks (N_{cb})
i. PSDU (Physical layer conformance procedure (PLCP) service data unit) length L_{psdu} in Bytes is first determined w.r.t to APEP length
ii. No. of Payload bits (N_{payloadbits}) is calculated by considering the service bits (N_{servbits})

$${N}_{p a y l o a d b i t s} = ( {L}_{p s d u} \times 8 ) / α + {N}_{s e r v b i t s}$$

iii. The number of information bits (k) per code block (CB) are calculated as k=R*L_{ldpc} where R is the code rate and L_{ldpc} is the length of LDPC code blocks.
iv. The number of code blocks are then calculated as

$${N}_{c b} = ⌈ \frac{{N}_{payloadbits}}{k} ⌉$$

Where ┌ ┐ represents ceil operation.
v. In case the number of transmit streams (nₛₛ) are greater than 1 then the number of code blocks in the previous step are refined as

$${N}_{c b} = ⌈ \frac{{N}_{cb}}{{n}_{ss}} ⌉ * {n}_{s s}$$

vi. Calculation of no. of OFDM symbols per stream initial (N_{ofpsinit}): The number of OFDM symbols required for transmission per stream is calculated as

$${N}_{ofpsinit} = ⌈ \frac{{N}_{c b} \times {L}_{ldpc}}{{n}_{sd} \times {n}_{s s} \times m} ⌉ ,$$

n_{sd} is the no. of data sub carriers, m is bits per QAM/PSK symbol.
vii. The actual number of code blocks are calculated as N_{cb}=┌N_{cb}*α┐

2. Code block Arrangement
(a) In case of single transmit stream transmission no special arrangement of codeblocks is required before feeding into LDPC encoder.
(b) In case the number of transmit streams are greater than 1, then integer number of codeblocks are transmitted per stream before feeding into LDPC encoder.
(c) As a result, code block arrangement has to be done per stream as shown below.

### Calculation of Number of Code Blocks Per Stream (N_{cbps})

Step 1: Calculate minimum integer no. of code blocks that can be transmitted per stream (q)

$$q = ⌊ \frac{{N}_{cb}}{{n}_{ss}} ⌋$$

where └ ┘ indicates the floor operation

Step 2: Calculate the remaining code blocks to be transmitted (r)
r=N_{cb}% nₛₛ (% is the modulo operation providing remainder after dividing N_{cb} with nₛₛ)

Step 3: These remaining ‘r’ code blocks will be less than no. of streams (nₛₛ). The division of codeblocks is made such that each stream carries one code block starting from first stream.

Calculate the no. of code blocks to be transmitted per stream (N_{cbps}) N_{cbps}=q×ones (1, nₛₛ)+[ones (1, r), zeros (1, nₛₛ−r)] where ones (1, r) create a row vector of 1's of size r & zeros (1, nₛₛ−r) creates a zero vector of zeros with size nₛₛ−r. N_{cbps} will be of size 1×nₛₛ.

A sample calculation employing N_{cb}=13 and 4 stream (nₛₛ) transmission is outlined below.

q=q=└13/4┘=3; r=(13% 4)=1; so, each stream will carry 3 code blocks. CB map is created as illustrated in Table 1. Code block arrangement as per CB map is shown in Table 2.

TABLE 1
Codeblock Map

| | | | | |
|---|---|---|---|---|
| Stream 1 | 1 | 1 | 1 | 1 |
| Stream 2 | 1 | 1 | 1 | 0 |
| Stream 3 | 1 | 1 | 1 | 0 |
| Stream 4 | 1 | 1 | 1 | 0 |

TABLE 2
Codeblock arrangement

| | | | | |
|---|---|---|---|---|
| Stream 1 | CB₁ | CB₂ | CB₃ | CB₄ |
| Stream 2 | CB₅ | CB₆ | CB₇ | |
| Stream 3 | CB₈ | CB₉ | CB₁₀ | |
| Stream 4 | CB₁₁ | CB₁₂ | CB₁₃ | |

No. of QAM/PSK symbols which can be transmitted per stream (Nₐₚₚₛ) Nₐₚₚₛ=N_{ofpsinit}×n_{sd}

The number of symbols per stream with the number of calculated codeblocks (N_{cbps}) are nₐₚₚₛ=┌N_{cbps}×L_{ldpc}/m┐

n_{apps_actual}=number of non-zero elements in the grid defined by the grid size and β₁ and β₂.

In case the number of BPSK/QAM symbols to be accommodated per stream, n_{apps_actual}is greater than available symbols nₐₚₚₛ, the number of OFDM symbols is incremented by 1 i.e N_{ofps}=N_{ofpsinit}+1 otherwise N_{ofps}=N_{ofpsinit}

So, the final number of (BPSK/QAM) symbols per stream will be Nₐₚₚₛ=N_{ofps}×n_{sd}

### 3. Calculation of OTFS Grid Size

Let M, N denote the number of grid points on the delay dimension and N denote the number of grid points on the doppler dimension. The value of N within range N1 to N2 is identified with the following process.
(a) We check if Nₐₚₚₛ is exactly divisible with N2 (zero remainder)
(b) If yes, we fix the N value to N2
(c) If no, we decrease the N value to N2−1 and repeat step (a) with N2−1
(d) We continue this process until N=N1
(e) Once N is fixed, we calculate M as

$$M = \frac{{N}_{q p p s}}{N}$$

### 4. Calculation of Number of Pre-FEC Bits (N_{prefecbits})

The number of Pre-FEC bits to be appended before FEC encoding is calculated as N_{prefecbits}=N_{cb}×L_{ldpc}×R−L_{psdu}×8−N_{servbits}

There is no need of adding shorten bits before LDPC Encoding with such calculation.

There is also no need of puncturing after LDPC Encoding.

5. Calculation of No. Of Post-FEC Symbols Per Stream (N_{postfecps})

Calculate no. of Post-FEC Symbols per stream N_{postfecps}=N_{qpps}−n_{qpps}.

The total Post-FEC symbols are the sum of Post-FEC symbols per stream

$${N}_{postfec} = {\sum }_{j = 1}^{{n}_{ss}} {N}_{postfecps} ( j )$$

Post-FEC symbols are populated with zeros in our transmission.

### 6. Power Scaling

In cases where the N_{postfec} is a non-zero number, the non-zero QAM/PSK symbols in each stream are power boosted by

$$\frac{MN}{{n}_{qpps \_ actual}}$$

### B. Receiver Architecture

At the receiver, with R receive antennas, the received signals y₁, y₂, . . . , yᵣ, . . . , y_{R} undergo conversion from Radio Frequency (RF) to baseband, and are synchronized in time and frequency. For each r^{th} receive antenna, after RF to baseband conversion and synchronization, OFDM demodulation is performed on the frame of N_{ofps} OFDM symbols. This process includes the fast Fourier transform (FFT) and removal of the Cyclic Prefix (CP) for each OFDM symbol. The RF to baseband conversion and time and frequency synchronization circuitry are omitted in FIG. 5. After OFDM demodulation, for a specific k^{th} tone, the output from R receive antennas is represented in vector form as

$$y ( k ) = {[ \begin{matrix}{y}_{1} ( k ) \\ {y}_{2} ( k ) \\ ⋮ \\ {y}_{r} ( k ) \\ ⋮ \\ {y}_{R} ( k )\end{matrix} ]}_{R \times 1} \qquad ( 6 )$$

where yᵣ(k) is the output for k^{th} tone from r^{th} receive antenna. The receiver block does iterative decoding as outlined in a co-pending Indian Patent Application number 202431059214

### C. Performance Evaluation:

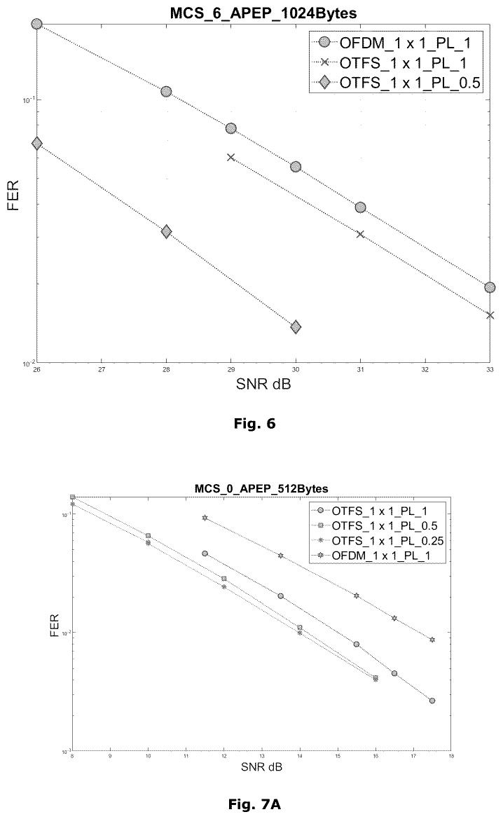

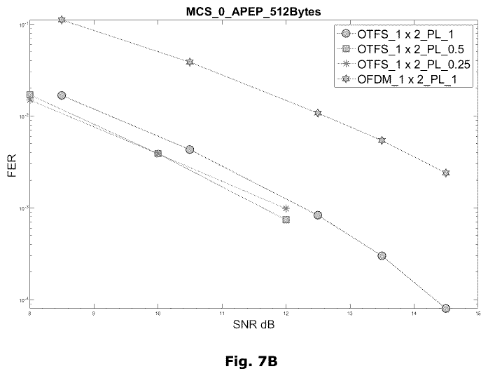

The simulation parameters are given in Table 3 (for FIG. 6) and Table 4 (for FIG. 7A and FIG. 7B) for testing the invented MIMO-OTFS transmission scheme with partial load and corresponding reception mechanism.

TABLE 3
Simulation Parameters

| Carrier frequency | 5 | GHZ |
|---|---|---|
| Channel | TGax, Model-B | |
| Velocity | 5 | kmph |
| Modulation | 64-QAM | |
| FEC coding | LDPC | |
| Load factors | β₁ = 1 β₂ = 1 [PL = 1] | |
| | β₁ = 2 β₂ = 1 [PL = 0.5] | |
| Codeblock length | 1944 | |
| APEP length | 1024 | Bytes |

| | |
|---|---|
| Code rate | ¾ |
| Max. number of receiver iterations | 10 |
| System (Transmit (T) × Receive (R)) | 1 × 1 |

TABLE 4
Simulation Parameters

| Carrier frequency | 5 | GHZ |
|---|---|---|
| Channel | TGax, Model-B | |
| Velocity | 5 | kmph |
| Modulation | BPSK | |
| FEC coding | LDPC | |
| Load factors | β₁ = 1 β₂ = 1 [PL = 1] | |
| | β₁ = 2 β₂ = 1 [PL = 0.5], | |
| | β₁ = 4 β₂ = 1 [PL = 0.25] | |
| Codeblock length | 1944 | |
| APEP length | 512 | Bytes |

| | |
|---|---|
| Code rate | ½ |
| Max. number of receiver iterations | 10 |
| System (Transmit (T) × Receive (R)) | 1 × 1 & 1 × 2 |

FIG. 6, FIG. 7A and FIG. 7B shows the Frame Error Rate (FER) for full load OFDM, OTFS and half load OTFS using non-codebook identity matrix-based precoding. It is found that OTFS performs better when compared to existing OFDM based Wi-Fi Transmission. With half load and quarter loading of OTFS grid, an improved error performance is attained when compared to full load OTFS with the invented transmission and reception methods. This helps in improved coverage and reliability of the link.

IEEE WLAN Standard 802.11bn is expected by 2028. However, the waveforms have not yet been finalized. The LDPC FEC mechanism needs to be supported apart from BCC. For high data rates MIMO Transmission is also key feature. Loading the OTFS grid by a reduced number of symbols than available provides coverage Enhancement and improved reliability.

### Uniqueness of the Present Invention:

1. A transmitter architecture for an Orthogonal Time Frequency Space (OTFS) waveform with Multiple Input Multiple Output (MIMO) configuration is provided for future Wi-Fi systems with partial loading (802.11be and 802.11bn) and multi-stream transmission.

2. LDPC encoding is supported by the advanced transmitter architecture of the present invention.

3. The advanced transmitter architecture adapts a new method of calculation of number of code blocks based on APEP length, coderate, length of LDPC codeblocks, number of streams and partial load factor.

4. The transmitter architecture is configured by OTFS grid size specially tunable with the partial load factor and zero symbols being loaded in the other points of the grid.

### Advantages of the Present Invention:

This invention incorporates OTFS along with multistream transmission and LDPC encoding with partial load into WLAN 802.11ax standard paving way for its inclusion in future Wi-Fi standards. This invention is a candidate of upcoming 802.11bn release of WLAN Communication system. To achieve improved error performance due to SNR gain, the present invention primarily can replace OFDM, which is used in existing Wi-Fi standards or can co-exist with systems supporting OFDM for backward compatibility. WLAN transmission equipment's and receivers interfacing with WLAN transmitters utilizing the above advanced technology can be derived.

1. A communication system including WLAN communication systems comprising:
transmitter including an OTFS grid based Orthogonal Time Frequency Space (OTFS) waveform generator and Multiple Input Multiple Output (MIMO) streams,
wherein said transmitter comprising signal processor including OTFS modulator having FEC (forward error correction) encoder for pre-FEC bit sequence-based encoding of input data stream and transmission of encoded input data stream in a selective sequence vide OTFS waveform modulated OTFS grid and with subcarrier including said OTFS grid partially loaded with QAM/PSK symbols of said encoded input data stream through MIMO transmitter and receiver streams including MIMO pre-coder based multi antenna support for said transmission and reception of said OTFS waveform that is OFDM modulated-demodulated thereby enabling OTFS waveform transmission and retrieval of input data stream.

2. The system as claimed in claim 1, wherein said transmitter includes
at least an input unit with the FEC encoder unit to receive input data stream and encode the same into LDPC code blocks divided across spatial streams;
said signal processor for processing the code block and obtaining corresponding QAM/PSK (quadrature amplitude modulation/phase shift keying) symbols of the data streams for including in a data vector of a length and partially loading vectors onto OTFS data grid; and
at least an input domain of MIMO pre-coding block based OTFS modulator having an inverse symplectic fast Fourier transform (ISFFT) based OTFS modulator for OTFS modulation of the data vector giving an output facilitated by multi-antenna transmission of ‘P’ parallel data streams matched to ‘T’ antennas for transmission;
at least an output domain of MIMO pre-coding block associated to OFDM modulator for communicating and mapping the MIMO output to OFDM modulator to generate time domain OFDM symbol, whereby said OFDM symbol through OFDM modulator is passed to a digital to analogue (D/A) converter and Radio Frequency (RF) chain for transmission at each mapped antenna.

3. The system as claimed in claim 2, wherein in said input unit prepend the input data stream with service bits, appended by Pre-FEC bits followed by scrambling the bit sequence at a scrambler module that is then FEC encoded at the FEC encoder module giving encoded LDPC codeblocks CB₁, CB₂, CB₃ . . . CBₚ at the output divided across spatial streams based on codeblock arrangement sequence in relation to desired signal processing.

4. The system as claimed in claim 2, wherein said signal processor for processing the code blocks in sequence include processing through bit interleaver, symbol mapper, post FEC symbol appender, symbol interleaver followed by power scalar for obtaining said corresponding QAM/PSK (quadrature amplitude modulation/phase shift keying) symbols per stream for including in a data vector and partially loading symbols/vectors onto OTFS waveform based data grid.

5. The system as claimed in claim 4 wherein the signal processor is configured for said partial loading I number of symbols, where I<MN number of QAM/PSK symbols transmitted instead of full (MN) number of symbols and I and MN are related to each other by ‘α’ which is a factor for partial loading as
$$I = α MN \qquad ( 1 )$$
and if the symbol vector is denoted by d=[d[0], d[1], . . . , d[i], . . . , d[I−1]]T for transmission in partial loading, such symbol vectors are sparsely loaded into M×N matrix \tilde{X} in a systematic form by maintaining a distance of β₁ between two consecutive symbols along row dimension and distance β₂ along the columns dimension with zero symbols filled in other positions of sparsely loaded matrix \tilde{X} where β₁ and β₂ are related to ‘α’ by the equation
$${β}_{1} {β}_{2} = 1 / α \qquad ( 2 )$$
and with the elements/components of vectors x(l, k) of \tilde{X} for l=0, 1, . . . , M−1 and k=0, 1, . . . , N−1 expressed for partially loading as
$$\tilde{x} ( l , k ) = \{ \begin{matrix}d [ i ] & if l = {( i )}_{\frac{\text{?}}{\text{?}}} {β}_{1} and k = ⌊ \frac{\text{?}}{\text{?}} ⌋ {β}_{2} \\ 0 & Otherwise\end{matrix} . \qquad ( 3 )$$
$$\text{?} \text{indicates text missing or illegible when filed}$$

6. The system as claimed in claim 1, wherein inverse symplectic fast Fourier transform (ISFFT) of the transmitter process the partially loaded data vector elements \tilde{x}(l, k) for OTFS modulation at the input domain side of MIMO pre-coding block based OTFS modulator as per the below
$${x}_{p} = ( {F}_{N}^{H} ⊗ {F}_{M} ) \tilde{x} , where {F}_{N}^{H} \qquad ( 4 )$$
is an inverse discrete Fourier transform (IDFT) matrix of order N and F_{M} is a DFT matrix of order M, and parameters M and N are grid parameters and their product MN=K, with OTFS grid size/parameters (M & N) computed such that if M, N denote the number of grid points on the delay dimension and N denote the number of grid points on the doppler dimension, the value of N within range N1 to N2 is processed based on the following computing logic:
(a) checking if Nₐₚₚₛ is exactly divisible with N2 (zero remainder);
(b) if yes, fixing the N value to N2;
(c) if no, the N value is decreased to N2−1 and repeating step (a) with N2−1;
(d) continuing computing until N=N1;
(e) once N is fixed calculating M as M=Nₐₚₚₛ/N; and
wherein for each k^{th} tone the input to the MIMO precoding block is expressed in terms of the OTFS samples xₚ=[xₚ(1), xₚ(2), . . . , xₚ(k), . . . xₚ(K)]^{T}, as
$$x ( k ) = {[ \begin{matrix}{x}_{1} ( k ) \\ {x}_{2} ( k ) \\ ⋮ \\ {x}_{p} ( k ) \\ ⋮ \\ {x}_{P} ( k )\end{matrix} ]}_{P \times 1} \qquad ( 5 )$$

7. The system as claimed in claim 2, wherein at the MIMO precoding block the P input samples are mapped to T antennas that are then placed onto data subcarriers of N_{ofps} OFDM symbols at each antenna by OFDM modulator, with the pilot symbols also undergoing MIMO precoding separately and are mapped to antennas and placed onto the pilot subcarriers, wherein inverse fast Fourier transform (IFFT) operation is involved to generate each time domain OFDM symbol to which a cyclic prefix (CP) is added by adder at OFDM demodulator and the N_{ofps} OFDM symbols as the output are passed to a digital to analog (A/D) converter and Radio Frequency (RF) chain for transmission at each antenna with T antennas transmitting T time domain signals, . . . , s₁, s₂ . . . s_{T}

8. The system as claimed in claim 2, wherein the signal processor is configured for computing number of Code Blocks Neb and finding number of OFDM symbols for transmission is based on the following processing:
viii. PSDU (Physical layer conformance procedure (PLCP) service data unit) length L_{psdu} in Bytes is first determined w.r.t to APEP length
ix. no. of Payload bits (N_{payloadbits}) is calculated by considering the service bits (N_{servbits})
$${N}_{payloadbits} = ( {L}_{psdu} \times 8 ) / α + {N}_{servbits}$$
x. the number of information bits (k) per code block (CB) are calculated as k=R*L_{ldpc} where R is the code rate and L_{ldpc} is the length of LDPC code blocks,
xi. the number of code blocks are then calculated as
$${N}_{cb} = ⌊ \frac{\text{?}}{k} ⌋$$
$$\text{?} \text{indicates text missing or illegible when filed}$$
Where ┌ ┐ represents ceil operation,
xii. in case the number of transmit streams (nₛₛ) are greater than 1 then the number of code blocks in the previous step are refined as
$${N}_{cb} = [ \frac{{N}_{cb}}{{n}_{ss}} ] * {n}_{ss}$$
xiii. calculation of no. of OFDM symbols per stream initial (N_{ofpsinit}): The number of OFDM symbols required for transmission per stream is calculated as
$${N}_{ofpsinit} = ⌈ \frac{\text{?}}{\text{?}} ⌉ ,$$
$$\text{?} \text{indicates text missing or illegible when filed}$$
n_{sd} is the no. of data sub carriers, m is bits per QAM/PSK symbol,
xiv. the actual number of code blocks are calculated as N_{cb}=[N_{cb}*α]

9. The system as claimed in claim 8, wherein sequential arrangement of the codeblock is based on the following computation:
(a) in case of single transmit stream transmission no special arrangement of codeblocks is required before feeding into LDPC encoder;
(b) in case the number of transmit streams are greater than 1, then integer number of codeblocks are transmitted per stream before feeding into LDPC encoder;
(c) as a result code block arrangement is done per data stream as below:
(i) computing the minimum integer number of codeblocks that can be transmitted per stream
$$q = ⌊ \frac{{N}_{cb}}{{n}_{ss}} ⌋ ,$$
where ┌ ┐ indicates the floor operation,
(ii) computing the remaining codeblocks that are to be transmitted based on r=N_{cb}% nₛₛ (% is the modulo operation providing remainder after dividing N_{cb} with nₛₛ) with the code block map corresponding to a code block arrangement per stream such that integer no. of code blocks are loaded per stream. Example arrangements are shown in tables below

| | | | | |
|---|---|---|---|---|
| Stream1 | CB1 | CB2 | CB3 | CB4 |
| Stream2 | CB5 | CB6 | CB7 | |
| Stream3 | CB8 | CB9 | CB10 | |
| Stream4 | CB11 | CB12 | CB13 | |
| | | | | |
|---|---|---|---|---|
| Stream1 | CB1 | CB2 | CB3 | |
| Stream2 | CB4 | CB5 | CB6 | CB7 |
| Stream3 | CB8 | CB9 | CB10 | |
| Stream4 | CB11 | CB12 | CB13 | |
| | | | | |
|---|---|---|---|---|
| Stream1 | CB1 | CB2 | CB3 | |
| Stream2 | CB4 | CB5 | CB6 | |
| Stream3 | CB7 | CB8 | CB9 | CB10 |
| Stream4 | CB11 | CB12 | CB13 | |
| | | | | |
|---|---|---|---|---|
| Stream1 | CB1 | CB5 | CB9 | CB13 |
| Stream2 | CB2 | CB6 | CB10 | |
| Stream3 | CB3 | CB7 | CB11 | |
| Stream4 | CB4 | CB8 | CB12 | |

the remaining ‘r’ code blocks will be less than no. of streams (nₛₛ) and the division of codeblocks is made such that each stream carries one code block starting from first stream.

10. The system as claimed in claim 8, wherein said (QAM/PSK) symbols numbers per stream (N_{qpps}) is computed as N_{qpps}=N_{ofpsinit}×n_{sd} with the number of symbols per stream with the number of calculated codeblocks (N_{cbps}) are nₐₚₚₛ=┌N_{cbps}×L_{ldpc}/m┐ and in case the number of BPSK/QAM symbols to be accommodated per stream, n_{apps_actual} is greater than available symbols nₐₚₚₛ, the number of symbols incremented by 1 i.e. N_{ofps}=N_{ofpsinit}+1 otherwise N_{ofps}=N_{ofpsinit}, with the final number of (BPSK/QAM) symbols per stream being Nₐₚₚₛ=N_{ofps}×n_{sd}.

11. The system as claimed in claim 3, wherein said Pre-FEC bits number computation is based on computing number of Pre-FEC bits to be appended before FEC encoding computed as N_{prefecbits}=N_{cb}×L_{ldpc}×R−L_{psdu}×8−N_{servbits} free of requirement of adding shorten bits before LDPC encoding and free of any puncturing after LDPC Encoding.

12. The system as claimed in claim 11 wherein number of Post-FEC symbols to be appended after the FEC bit interleaving and symbol mapping per stream is computed as N_{postfecps}=Nₐₚₚₛ−nₐₚₚₛ where the total Post-FEC symbols are the sum of Post-FEC symbols per stream
$${N}_{postfec} = {\sum }_{j = 1}^{{n}_{ss}} {N}_{postfecps} ( j )$$
and post-FEC symbols are populated with zeros in our transmission.

13. The system as claimed in claim 4, wherein said power scalar in cases where the N_{postfec} are non-zero, the non-zero QAM/PSK symbols in each stream are power boosted by M×N/n_{qpps_actual}

14. The system as claimed in claim 1, wherein said receiver with R receive antennas, receive data stream signals y₁, y₂ . . . y_{R} that undergo conversion from Radio Frequency (RF) to baseband, and are synchronized in time and frequency such that for each r^{th} receive antenna, after RF to baseband conversion and synchronization, OFDM demodulation is performed on the frame of (N_{ofps}) OFDM symbols by involving fast Fourier transform (FFT) and removal of the Cyclic Prefix (CP) for each OFDM symbol, whereby after OFDM demodulation, for a specific k^{th} tone the output from R receive antennas is computed in vector form as
$$y ( k ) = {[ \begin{matrix}{y}_{1} ( k ) \\ {y}_{2} ( k ) \\ ⋮ \\ {y}_{r} ( k ) \\ ⋮ \\ {y}_{R} ( k )\end{matrix} ]}_{R \times 1} , \qquad ( 6 )$$
where yᵣ(k) is the output for k^{th} tone from r^{th} receive antenna with the receiver adapted for data retrieval.
